(19) United States
(12) Patent Application Publication
(10) Pub. No.: US 2011/0218047 A1
(43) Pub. Date: Sep. 8, 2011

(54) BUMPER SYSTEM FOR GO-KARTS AND GO-KART TRACKS

(75) Inventors: James J. Kessler, Winter Garden, FL (US); James L. Warner, III, Williamsville, NY (US); Stephen J. Kessler, Amherst, NY (US)

(73) Assignee: TRON RACING, LLC, Amherst, NY (US)

(21) Appl. No.: 13/042,195

(22) Filed: Mar. 7, 2011

Related U.S. Application Data
(60) Provisional application No. 61/311,046, filed on Mar. 5, 2010.

(51) Int. Cl. A63G 21/04; B60R 19/42; A63C 19/00; B60K 1/00; H02J 7/00

(52) U.S. Cl. 472/89; 293/120; 180/65.1; 293/117; 320/109

(57) ABSTRACT

A bumper assembly including a backing, wherein the backing is substantially rigid, an outer layer, wherein the outer layer semi-flexible, resilient, and non-conductive, a cushion layer sandwiched between the backing and the outer layer, wherein the cushion layer is resiliently compressible.

### CROSS-REFERENCE TO RELATED APPLICATIONS

This patent application claims the benefit under 35 U.S.C. §119(e) of U.S. Provisional Patent Application No. 61/311,046, filed Mar. 5, 2010, which application is incorporated herein by reference.

### FIELD OF THE INVENTION

The invention broadly relates to recreational go-kart amusements, more specifically for a go-kart and track bumper system.

### BACKGROUND OF THE INVENTION

Recreational go-kart amusements provide a real racing experience on a lower speed track suitable for the general public. Although bumping is not advised, and often prohibited, collisions between other go-karts and the walls that define the track are a frequent occurrence. One commonly known bumper system for go-karts is a continuous steel band, which surrounds the kart. The band may have a width or height of between two to four inches. The band is mechanically mounted to the frame of the go-kart by supports, which may be surrounded by damping sleeves, such as made from rubber or some other resilient material. The sleeves act as dampeners to help absorb any shock or force that the kart may experience during a collision or impact, but there is still a rigid connection between the outer portion of the bumper and the vehicle's body. By providing bumpers that protect the entire go-kart, the occupant of the kart will have some protection in the event of a collision with another go-kart or with a bumper wall that surrounds the track on which the go-kart is used. The bumper walls that define go-kart tracks are also often similar rigid steel frames, including a damping means behind the rigid frame. Often, this dampening means comprises old rubber tires which are laid on their sides, behind the metal bumper for absorbing a portion of the forces that occur in a collision.

While the metal frame and rubber tire style bumper works sufficiently, it takes up a lot of space, and is therefore not suitable for indoor use. Also, the typical means by which a go-kart is powered is by a gasoline engine, which produces exhaust fumes and also not suitable for indoor use. Thus, the operation of go-carts is limited to locations or seasons that permit outdoor operation. Electric powered vehicles are becoming known which are now powerful enough to provide the necessary speed and torque to provide a fun racing experience. Electric powered go-karts however, must be recharged between each race, which can limit the length of races or time between races. Pit lanes must be adapted to include charging contacts for charging the batteries of the go-karts between races. These charging contacts must be supplied with large currents by high gauge wires. Typically, these contacts are supplied on the underside of the vehicle and the top of a pit lane. However, this requires installation of the high gauge wires underneath the pit lanes, which requires, for example, construction of the pit lanes on a raised platform, or demolition of the concrete or cement flooring in order to cut trenches for the wires.

For the safety of the drivers and the protection of the vehicles, one rule essentially always implemented at go-kart establishments is the prohibition on intentional bumping of one go-kart into another. This rule is enforced because bumping can lead to dangerous driving and result in high speed crashes. The prior art metal bumper is typically suitable for protecting the driver of the vehicle, but is very stiff and accordingly insufficient to prevent damage to the vehicles during high speed collisions. Consequently, if the go-kart is subjected to a hard impact, as frequently occurs, there is a large potential for structural damage to the go-kart or to the bumper. For example, the go-kart may suffer severe mechanical and structural damage because the impact is received and transferred by a rigid steel bumper directly to the body of the kart. Even if the body of the kart is undamaged, the rigid outer bumper may become bent or mangled. In some cases, the bumper may become so distorted that it disrupts the kart's ability to drive. Although rubber sleeves or other dampening means may be included between the outer frame and the body of the kart, these are usually not sufficient to protect the karts from suffering damage during even relatively mild impacts, as there still must be rigid structural supports supporting the outer bumper on the body of the kart.

### BRIEF SUMMARY OF THE INVENTION

The present invention broadly comprises a bumper assembly including a backing, wherein the backing is substantially rigid, an outer layer, wherein the outer layer semi-flexible, resilient, and non-conductive, a cushion layer sandwiched between the backing and the outer layer, wherein the cushion layer is resiliently compressible. In one embodiment, the outer layer comprises hard plastic and the cushion layer comprises foam rubber. In one embodiment, the bumper assembly is installed as a substantially continuous ring about a go-kart. In one embodiment, the go-kart comprises a chassis, the chassis comprises the backing, wherein the outer layer comprises hard plastic, and wherein the cushion layer comprises foam rubber. In one embodiment, the outer layer comprises an outer lateral surface, and wherein at least one conductive contact is arranged on the outer lateral surface, and wherein the at least one conductive contact is electrically connected to a rechargeable battery of the go-kart.

In one embodiment, the bumper assembly is arranged on a floor to define a track for vehicles, wherein the outer layer faces the track. In one embodiment, the assembly further comprises a plurality of rods vertically extending from the floor at spaced intervals behind the backing for rigidly supporting the bumper assembly. In one embodiment, each of the rods includes a portion that extends down into the floor. In one embodiment, a brittleness of each of the rods enables the rods to shear or break between the backing and the floor if the rods experience a threshold force exerted by the backing. In one embodiment, the assembly further comprises a plurality of ties, wherein each of the ties corresponds with one of the rods, and each tie is operatively arranged for securing the outer layer, the cushion layer, and the backing to one of the rods. In one embodiment, the ties comprise plastic tie-wraps.

In one embodiment, the backing comprises first and second backings, the cushion layer comprises first and second cushion layers, and the outer layer comprises first and second outer layers, wherein the first cushion layer is sandwiched between the first outer layer and the first backing for forming a first bumper portion and wherein the second cushion layer is sandwiched between the second outer layer and the second backing for forming a second bumper portion, and wherein the first and second bumper portions are arranged on oppositely disposed sides of the rods. In one embodiment, the assembly further comprises a plurality of ties, wherein each of the ties corresponds to one of the rods, and wherein each of the ties is operatively arranged to secure both of the first and second bumper portions to common ones of the rods.

The current invention also broadly comprises a system for electric vehicles including a track, a pit area connected to the track and having at least one charging station, the charging station including a battery charger providing a voltage source, at least one first contact electrically connected to the charging station, wherein the at least one first contact is arranged on a vertically oriented surface of the charging station, and an electric vehicle including a rechargeable battery, a bumper having an outer lateral surface, and at least one second contact electrically connected to the rechargeable battery for completing a charging circuit between the battery charger and the battery when the second contact is engaged against and electrically connected to the first contact for recharging the battery.

In one embodiment, a cushion layer is provided behind the at least one first contact for enabling the at least one first contact to flex away from the bumper in case of interference between the at least one first contact and the at least one second contact for providing mating engagement of the first and second contacts against each other. In one embodiment, the at least one first contact comprises two first contacts, the at least one second contact comprises two second contacts, and wherein a charging circuit for recharging the battery is completed only when each first contact is engaged against and conductively connected with respective ones of the second contacts.

The current invention also broadly comprises a charging station including a battery charger providing a voltage source, two conductive faceplates, wherein each conductive faceplate is electrically connected to the battery charger, wherein both of the conductive faceplates are arranged on a vertical surface. In one embodiment, a cushion layer is provided behind the conductive faceplates for enabling the faceplates to move forward and back with respect to the vertical surface.

It is a general object of the present invention to provide a charging system for an electric vehicle where conductive contacts are provided in lateral or vertically orientated surfaces.

It is another general object of the present invention to provide a space saving bumper design for a vehicle track.

It is yet another object of the present invention to provide a bumper design for a vehicle, such as a go-kart, that has an outer shell that is not rigidly connected to the body of the go-kart.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a top view of a go-kart track system;

FIG. 2A is a perspective view of a track bumper;

FIG. 2B is a perspective view of a track bumper;

FIG. 3 is a perspective view of a reverse side of a track bumper;

FIG. 4A is a perspective view of a track bumper joint;

FIG. 4B is a perspective view of a track bumper joint with a section of the bumper removed;

FIG. 5A is a perspective view of a bumper for a hairpin turn;

FIG. 5B is a perspective view of a bumper for a wider turn;

FIG. 6A is a side view of a go-kart in a pit area;

FIG. 6B is a simplified schematic of a charging circuit for recharging a battery of a go-kart;

FIG. 7A is a perspective view of a contact assembly for a go-kart charging station;

FIG. 7B is a perspective exploded view of a contact assembly for a go-kart charging station;

FIG. 8 is a perspective view of charging stations in a pit lane;

FIG. 9A is a perspective partially exploded view of a wall for a go-kart charging station;

FIG. 9B is a perspective exploded view of a wall for a go-kart charging station;

FIG. 10A is a perspective exploded view of a bumper for a go-kart; and,

FIG. 10B is a perspective view of a bumper for a go-kart.

### DETAILED DESCRIPTION OF THE INVENTION

At the outset, it should be appreciated that like drawing numbers on different drawing views identify identical, or functionally similar, structural elements of the invention. Additionally, it should be appreciated that the use of a trailing letter or prime symbol (′) to append a reference numeral is merely to differentiate between different instances of similar components for ease of discussion or to indicate that two or more elements are similar, related, or alternatives, but that each element having the same base numeral could generally resemble all other elements having that same base numeral, regardless of trailing character, unless otherwise described. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

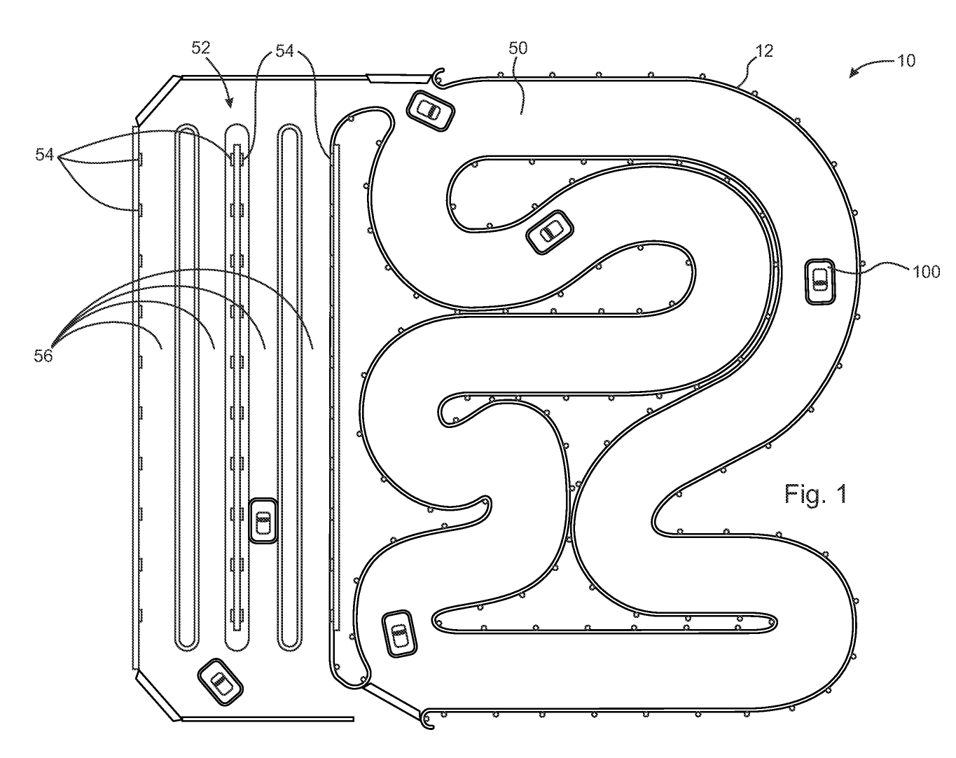

Referring now to the figures, FIG. 1 shows system 10, which comprises track 50 defined by bumper assembly 12. The track is arranged as a course or circuit for vehicles, such as go-karts 100 (or simply “karts”) to race about for fun or for competition. As discussed in more detail below, go-karts 100 are electric vehicles having rechargeable batteries. In order to recharge the batteries of the karts, system 10 includes pit area 52 attached to track 50, the pit area having a plurality of battery chargers 54, discussed in more detail below. In the embodiment of FIG. 1, the pit area is divided into four pit lanes 56, although it should be understood that a different number of lanes could be provided.

Track bumper assembly 12 generally includes outer shell 14 and backing 15, between which intermediate cushion 16 is sandwiched. Cushion 16 is secured between outer shell 14 and backing 15, for example, by use of tie-wraps 18. The tie-wraps may be, for example, heavy duty plastic tie wraps, or some other strap-like securing device, such as metal or plastic bands, ropes, cables, or the like. The tie-wraps are also be used to secure the outer shell, backing, and cushion layer to support rods 20. Adhesives or glue may be used in addition to, or in lieu of, the tie-wraps to help bind the outer shell to the inner cushion. Rods 20 provide additional support for the bumper in the event of a collision with the track bumper, such as by a go-kart.

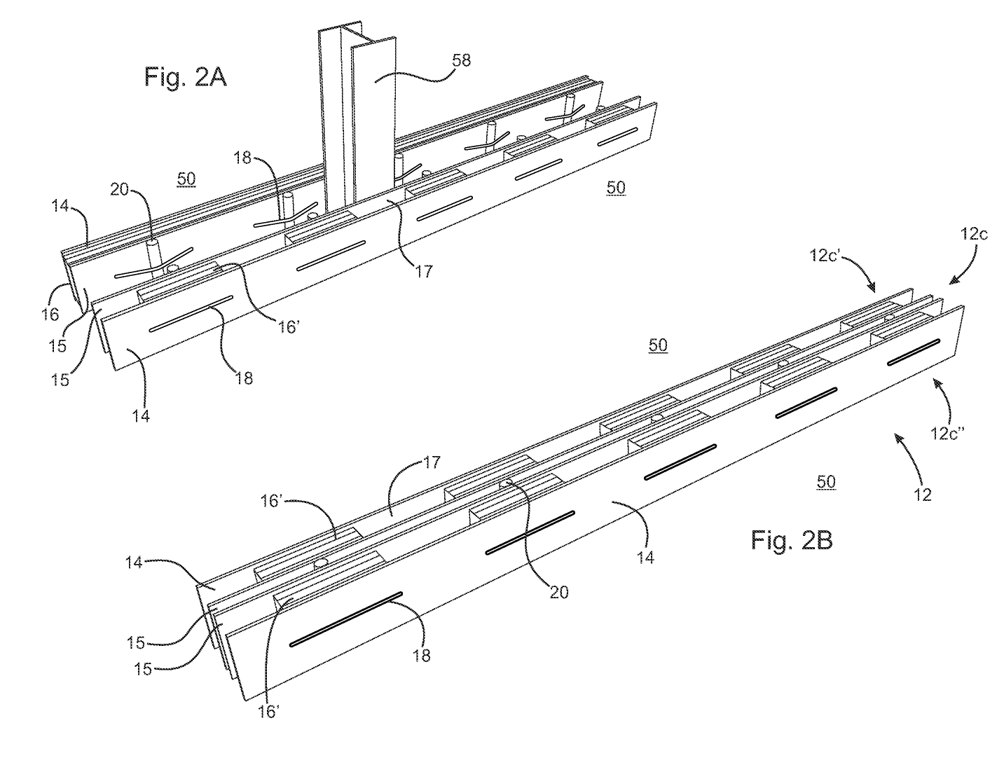

Various bumper styles are shown throughout the Figures, with FIGS. 2A and 2B illustrating bumpers 12a, 12b, and 12c. It should be understood that any description of bumpers 12 or components of bumpers 12 apply generally to bumpers 12a, 12b, and 12c, unless otherwise noted. In FIG. 2A, two bumpers are arranged on opposite sides of vertical support beam 58 in order to protect karts from being able to hit the support beam. Such a support beam, or some other obstacle or obstruction, may be present, for example, if the track is installed indoors, which is one advantageous use of the current invention. In FIG. 2A cushion 16 of bumper 12a is formed as a continuous layer between the outer shell and backing, while the cushion in bumper 12b is formed from discrete or individual bumper sections 16′, with gaps 17 located between the bumpers. It should likewise be understood that any description of cushion 16, or the functions or advantages thereof, applies generally to cushion sections 16′ unless otherwise specified. In one embodiment, such as those shown with respect to bumpers 12b and 12c, each cushion section could correspond to a separate set of rods.

Bumper 12c in FIG. 2B is formed from two bumper sections, namely, sections 12c′ and 12c″, with both sections having outer shell 14, backing 15, and cushion 16, but with both sections sharing a common set of rods 20, thereby further reducing the area required to install the bumper where track 50 is located on both sides of the bumper. Like bumper 12b, bumper 12c is also shown having discrete bumper sections 16′ as opposed to a continuous cushion layer. However, it should be appreciated that any combination of discrete and/or continuous cushions could be used as desired in embodiments of the current invention. Providing discrete cushion sections 16′ may increase the ability of the outer shell of the bumper to flex in response to a collision and requires less material, while a continuous cushion may provide more force absorption capabilities, but reduce the amount of flexing by the outer shell of the bumper.

Thus, it may be desirable to use a relatively thicker outer shell with discrete cushion sections 16′ than would be used with continuous cushion 16, but the particular dimensions should be determined, for example, based on the speed, size, weight, etc., of the karts with respect to the performance and safety requirements for each particular track. In some embodiments, each rod corresponds to one tie-wrap, with the tie-wrap looped about the rod and the outer shell to secure the rod, outer shell, and cushion together. In the dual bumper arrangement of bumper 12c, the tie-wraps could additionally be secured between both outer shells 14, both backings 15, and both cushion sections 16′. In this way, according to FIG. 2B, a suitable bumper could be provided for adjacent sections of track 50 in an even further space and material saving manner.

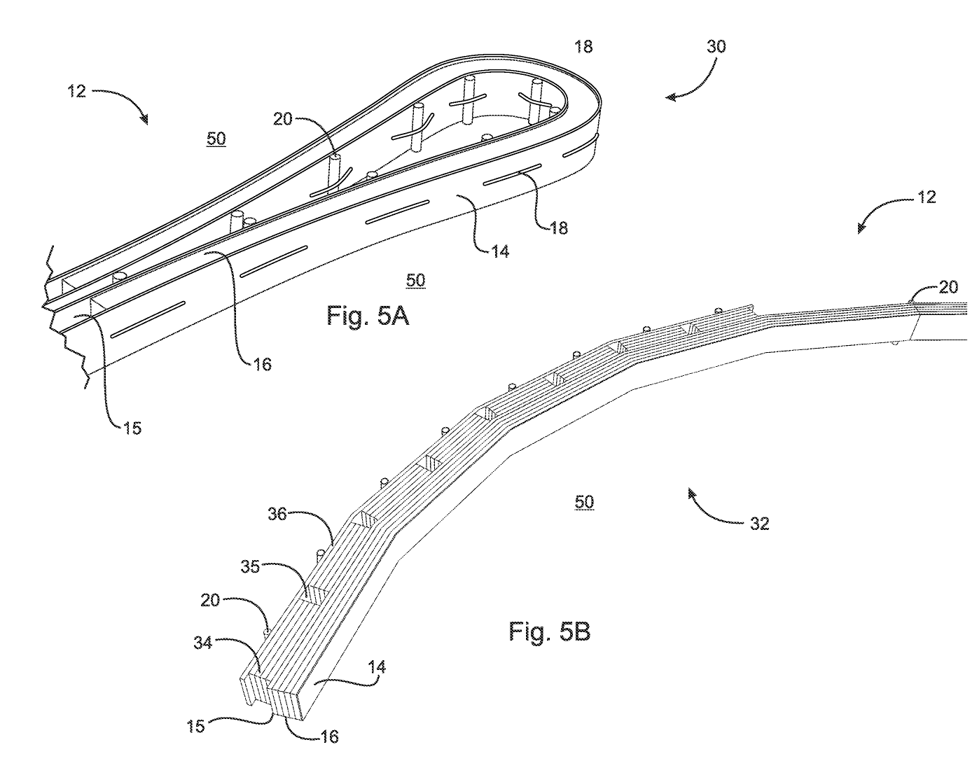

As one example, cushions 16 are shown in many of the Figures as made from three layers of material. Specifically, in some embodiments, the cushions are made from three layers of 1.25″ thick foam rubber. Layers are used because foam rubber sheets are not generally made having greater thicknesses, but it should be understood that more or less layers of other thickness could be used. For example, in the turn of FIG. 5A, described in more detail below, the cushion layer is shown as a solid continuous block of material. It should thus be appreciated that any cushion could be replaced by cushion formed from a single block of material, instead of three layers, or that a different number of layers could be utilized. It should also be appreciated that other materials could be used in lieu of foam rubber, but that preferred materials would have good compressibility in order to absorb the shock or force from collisions for protecting the driver of a go-kart that collides with the bumper, the go-kart, and the bumper. Furthermore, it may be advantageous to select material for the cushion that is not easily permanently deformed, but that expands back to its original size and shape after the collision such that the bumper is repeatedly ready to absorb the shock of subsequent collisions. The overall thickness of the cushioning of the bumper should be set with respect to the compressibility and/or shock absorbing capabilities of the cushion, the level of performance desired from the cushion, and any other factors important to the owner or operator of the track. The outer shell and backing are provided as much harder and stiffer than the cushion, in the form of hard plastics, or the like, in order to protect the less durable foam layers and to spread the force of a collision out over a wider area of the bumper so that forces can be more easily absorbed by the cushioning layer.

Outer shell 14 is made, for example, from resilient and durable material, such as a hard plastic of about 0.25″ or 0.5″ inch thickness having a haircell texture on its outer surface. At this thickness, the outer shell is still semi-flexible, but still rigid enough to provide proper support for a bumper. Backing 15 may be, for example, a 1″ thick hard plastic layer. In this described embodiment, the backing is thicker than the outer shell in order to provide rigidity to the bumper, specifically to provide a surface against which the bumper can compress, while the outer shell is thinner because it enables some degree of flexing of the outer shell, which may help disperse forces in a collision. However, it should be understood that other thicknesses, relative sizes of the thicknesses, or materials could be used for creating a bumper according the current invention. Also, different sections or portions of the outer shell or backing for the bumper could vary in thickness, to provide more support and less flexibility to certain sections, such as around corners, or wherever desired. In one embodiment, rods 20 are 1.5″ diameter fiberglass reinforced hard plastic rods. The fiberglass reinforcement is used, for example, to strengthen the rod, although it should again be understood that other materials or dimensions could be used in lieu of those examples explicitly described herein.

Accordingly, it should be understood that the current invention bumper could be created for a go-kart track that is much thinner than the prior art. For example, a bumper having the dimensions described above could have a total thickness of only about six inches. As discussed above, go-kart tracks were traditionally required to be built outdoors, and therefore, the size of the bumper system did not really matter as a lot of space is available outdoors. However, with the advent of electric go-karts, emissions are no longer an issue and it has become practical to install go-kart tracks indoors. As a result, the size of the track is limited by the size of the building, thus making the task of reducing the size of the bumper absolutely critical. For example, one may wish to convert an old warehouse, or the like, into a go-kart track and thus be limited by the size of the warehouse.

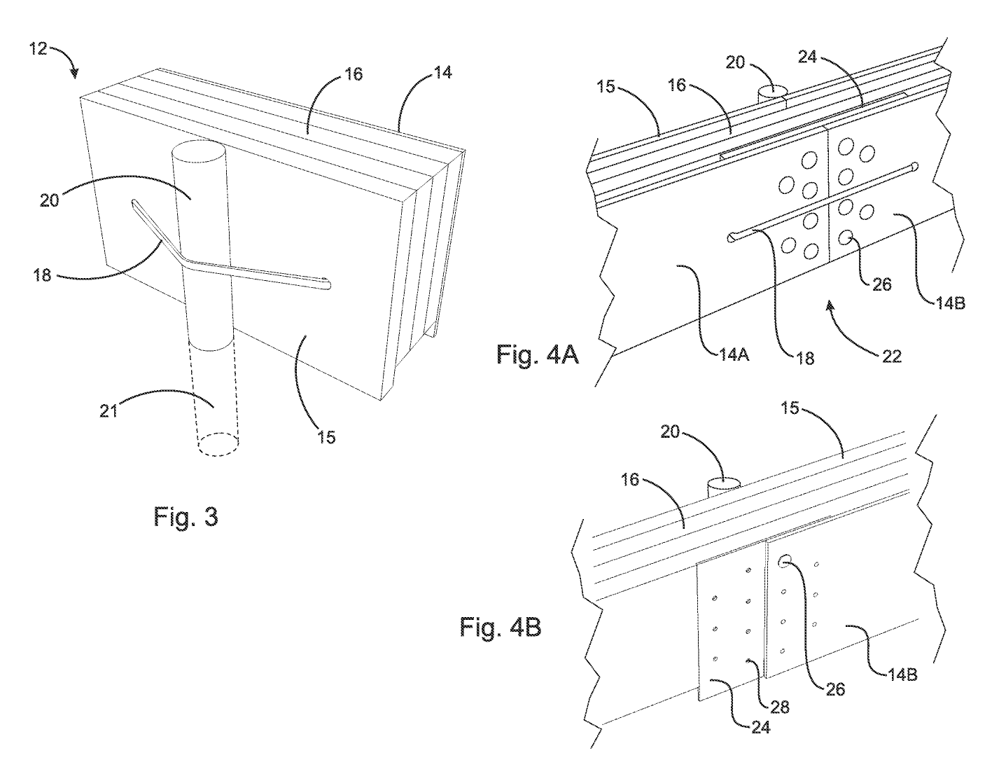

Rods 20 could have different diameters or cross-sectional shapes as desired, such as polygonal shapes. In one embodiment, the rods are made from plastic and intended to be “sacrificial” in the event of a collision with the wall. By this, it is meant that the rods will break or shear, instead of holding firm and potentially damaging a kart which has contacted the bumper wall, or damaging the floor of the track into which they are mounted, or hurting a driver by abruptly stopping a kart in a severe collision. For example, in one embodiment, the rods are driven, screwed, force fit, or otherwise engaged with the floor forming track 50. That is, as shown in FIG. 3, rods 20 may have portion 21 that extends into the floor. With respect to this embodiment, fiberglass reinforced plastic rods may be used to provide sufficient brittleness for the rods to enable rods 20 to sacrificially shear between the backing and the floor when a force is exerted by the backing on the rod, such as when a go-kart collides with a bumper proximate a rod. Thus, for example, in the event of a particularly severe collision between a go-kart and a bumper, the rod will simply shear in half instead of holding firm or bending, thus allowing the bumper to move or flex along with the go-kart to some degree. This is provided as an additional safety feature because if the rod did not break in a severe collision, such as if the go-kart is moving very fast, then the bumper would cause the go-kart to come to a complete stop very abruptly, and abrupt stops tend to transfer a large amount of force to the driver, such as in the form of whiplash. It may also result in the other components of the bumper or the kart to become damaged. By enabling the rods to break, the time period over which bumper 12 stops a colliding go-kart would be increased as the bumper moves, shifts, or flexes with the go-kart, thus decreasing the severity of the crash felt by the driver, the bumper, and the kart. The bumper could then be put back in place, and the broken rod discarded and replaced by a new rod. In this way, the rods can provide a cheap, effective, and quickly repairable safety feature for bumpers 12 of system 10.

An example of a bumper wall joint is shown in FIGS. 4A and 4B. That is, joint 22 is created at the boundary between two pieces of outer shell 14, namely, first shell portion 14A and second shell portion 14B. For example, it is not feasible to form the entire outer shell from a single piece of material, and therefore, it will likely be required to secure multiple pieces together. Backing plate 24 is included, with half of the backing plate secured to each of shell portions 14A and 14B by fasteners 26, which are inserted into holes 28. Cushion 16, or a layer thereof, may be modified with a section removed, for example, in order to accommodate inclusion of backing plate 24. The fasteners could be, for example, screws, bolts, ratchet fasteners, rivets, or the like. Alternatively, the fasteners could be replaced by, or supplemented with, glue, epoxy, or other adhesives. Additionally, in the embodiment of FIGS. 4A and 4B, joint 22 is positioned such that a tie-wrap is connected between the two shell portions for more securely securing the two shell portions together (although the tie-wrap is not shown in FIG. 4B for clarity). In FIG. 4B, joint 22 is illustrated with shell portion 14A removed, providing a better view of joint 22 and plate 24. A substantially identical system could be used for securing multiple sections of backing 15 together. Since the joints may not be as strong as the remainder of the bumper, it may be advantageous to stagger the backing joints from the outer shell joints so that the joints are not aligned with each other. It may also be advantageous to align each joint, whether for the backing or the outer shell, with rods 20, as shown, in order to further support the joints.

In FIG. 5A, bumper 12 is shown doubling back on itself to create hairpin turn 30. In this embodiment, the bumper splits from resembling a dual-bumper (e.g., resembling bumper 12c) to a single bumper, before being recombined after the turn. Additionally, in this embodiment, cushion 16 is included about the entire length of turn 30 for providing sufficient support in the event that a kart collides with the bumper at this location, and also to maintain the shape of the turn. FIG. 5B illustrates wider turn 32, which would be used for right angle turns, or the like. Since crashes with the wall are most likely to occur at or near the turns, the bumper of system 10 may need to be additionally reinforced at the turns. For example, in turn 32, auxiliary cushions 34 are included in addition to bumper 12 in order to provide a further layer of cushioning. The auxiliary cushions are shown as discrete portions or sections with gaps 35 between them, but it should be understood that the auxiliary cushion could extend continuously behind bumper 12, similar to cushions 16 and sections 16′ discussed above. Cushion sections 34 are placed behind backing 15 of bumper 12, with auxiliary backing 36 located behind cushion sections 34 and rods 20 located behind the auxiliary backing

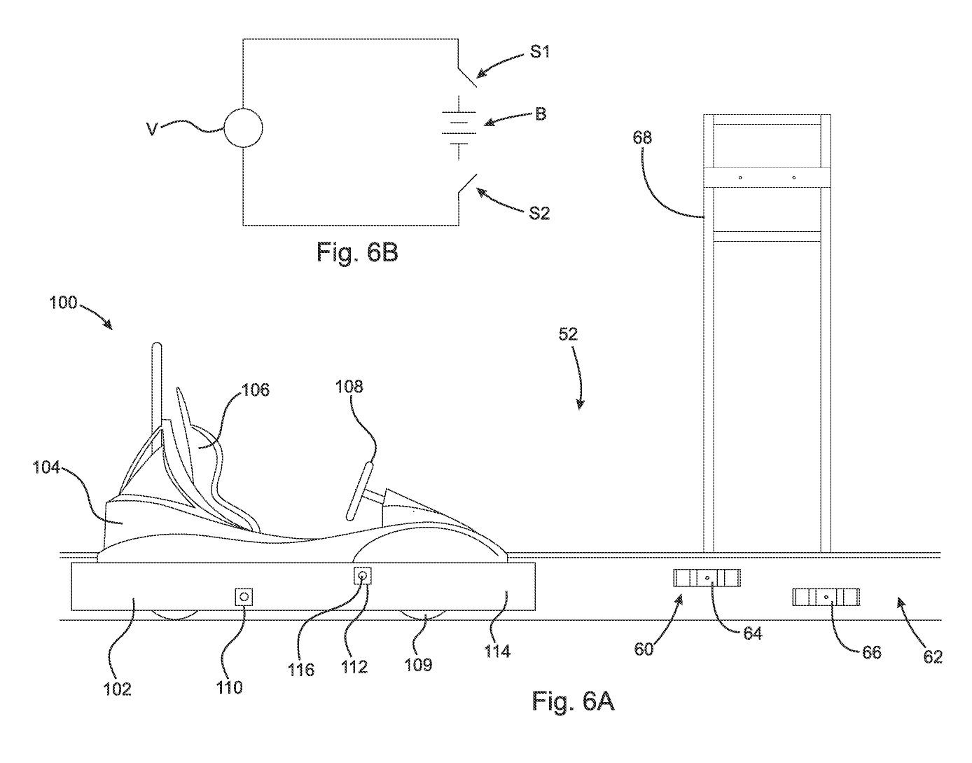

FIG. 6A shows go-kart 100 in pit area 52. Each go-kart 100 includes bumper 102, body/chassis 104, seat 106, steering device 108, and charging contacts 110 and 112. Bumper 102 is included for protecting body 104 of each kart, and each kart in general, as well as for cushioning a collision between two karts or between a kart and a bumper in order to protect a driver of the kart sitting in seat 106. Go-karts 100 are preferably electrically powered and steering devices 108 are included as electro-mechanical devices for turning drive wheels 109 of the kart, delivering more or less power to certain wheels (overpowering wheels on one side of the kart will help the kart turn toward the opposite side), etc., in order to turn the go-kart. Contacts 110 and 112 are included for charging a battery or battery pack of the go-kart and are located on lateral surface 114 of bumper 102, unlike contacts for prior art electric go-karts that have charging contacts located and the underside those karts. Each contact may include conductive bolt 116, or the like, for electrically or conductively connecting the contacts with the battery of the karts via suitable wiring.

The pit lanes of the pit area are included both for storage of the karts when not in use, and for recharging of each kart's battery. For example, charging station 60 is formed in vertical surface 62 by contact assemblies 64 and 66. Framework 68 is shown in FIG. 6A, onto which framework chargers 54, and any other necessary charging electronics could be secured for connection to contact assemblies 64 and 66. That is, the contact assemblies are in electrical communication with a power source, e.g., chargers 54, for forming a charging circuit to charge a go-kart when the contacts of the go-kart come into contact with contacts of the charging station. For example, this is illustrated schematically in the simplified circuit of FIG. 6B. In FIG. 6B, the charging circuit includes voltage source V, switches S1 and S2, and battery B. In one embodiment voltage source V is a 24V battery charger. For example, voltage source V generally represents battery chargers 54, and battery B represents the battery of any go-kart 100, while the switches schematically illustrate the coupling/decoupling of go-kart contacts 110 and 112 with charging station contacts 64 and 66. That is, for example, when contacts 110 and 66 are in contact, switch S1 would be closed, and when contacts 112 and 64 are in contact, switch S2 would be closed, with the circuit completed and battery B recharging only if both switches are closed. Rechargeable batteries and their accompanying circuits are well known in the art and could take any form or style, such as lithium ion, lithium iron phosphate, nickel cadmium, lead acid, etc.

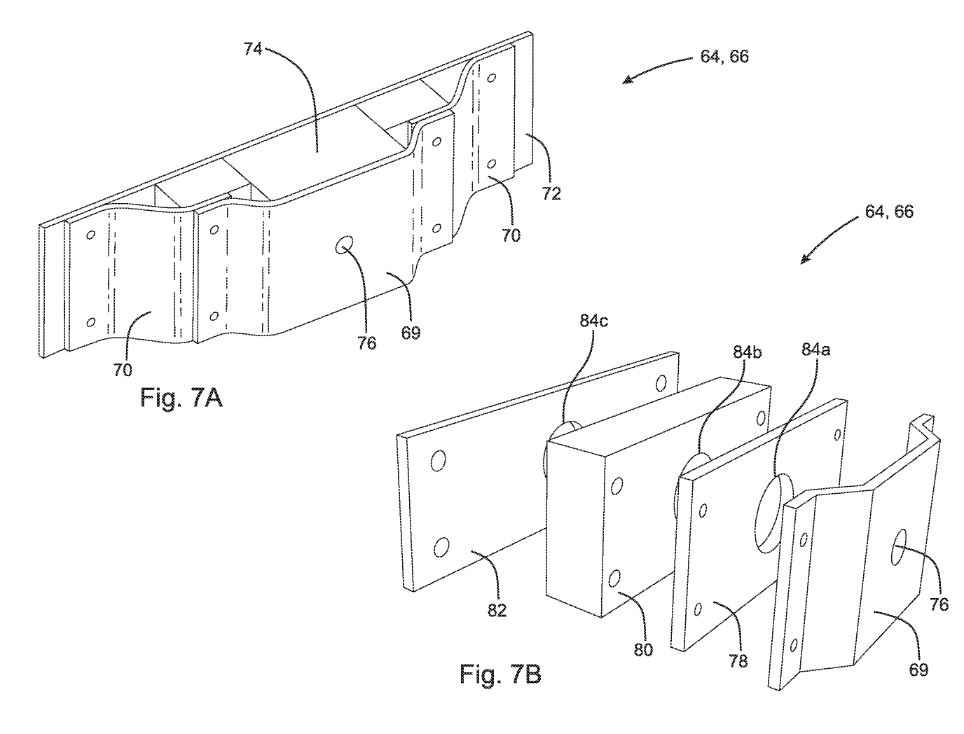

Two possible embodiments for contact assemblies 64, 66 are shown in FIGS. 7A and 7B. Conductive faceplate 69 of the assemblies may be supported by resilient or spring-like spacers 70, such as made from metal or plastic, which can partially flex is the contact is pressed inwards. Faceplates 69 substantially resembles contacts 110 and 112 of the go-kart bumper in both structure and function, as conductive plates for enabling completion of the charging circuit. The spacers are affixed, for example, to backing plate 72. The backing plate is affixable to vertical surface 62. Cushion layer 74 is included behind the faceplate to enable the contact to partially flex or compress towards the wall when a kart is driven into a pit lane, without causing damage to the kart of charging station. For example, the pit lanes must be narrow enough to ensure an electrical connection is always formed between the faceplates of contact assemblies 64 and 66 and go-kart contacts 110 and 112 when the karts are in the charging stations. A conductive bolt, screw, pin, or the like would be secured in central bore 76 in order to electrically connect the faceplate to the rest of the charging circuit with suitable wiring. In FIG. 7B, the contact assemblies include face plate 69, but with a cushion layer 80 sandwiched between plates 78 and 82. Bores 84a, 84b, and 84c are provided in order to enabling wiring to extend to faceplate 69 and/or the bolt, pin, or screw in bore 76 of the faceplate. It should be appreciated that the contact assemblies could take various other forms, and that these embodiments are provided as examples only.

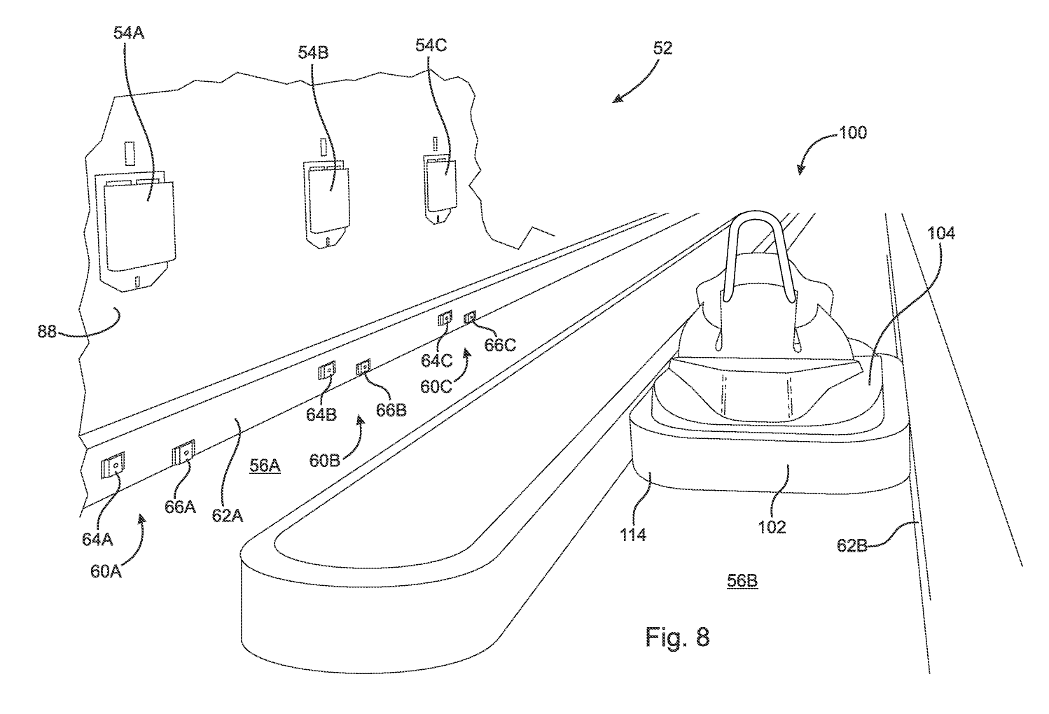

Pit lanes 56A and 56B are shown in FIG. 8, with go-kart 100 parked in lane 56B. A bank of battery chargers 54 are shown along the length of pit lanes 56A, namely designated as chargers 54A, 54B, and 54C. Each charger corresponds to a charging station, namely, stations 60A, 60B, and 60C correspond to chargers 54A, 54B, and 54C, respectively.

For example, charging station 60A might include charging contact assemblies 64A and 66A and charger 54A for charging a first kart, while station 60B might include charging contacts 64B and 66B and charger 54B for charging a second kart, and station 60C might include charging contacts 64B and 66B and charger 54B for charging a third kart and so on for each charging station. In this way, multiple karts can be simultaneous charged. Thus, the number of charging stations included in the pit area could equal the number of karts which can be simultaneously driven on track 50. Alternatively, there could be twice the number of charging stations as karts, such that half of the karts could be charging while the other half are driving. It should be appreciated that substantially identical charging stations would be provided for lane 56B, with the contact assemblies installed in vertical surface 62B, which vertical surface borders that lane.

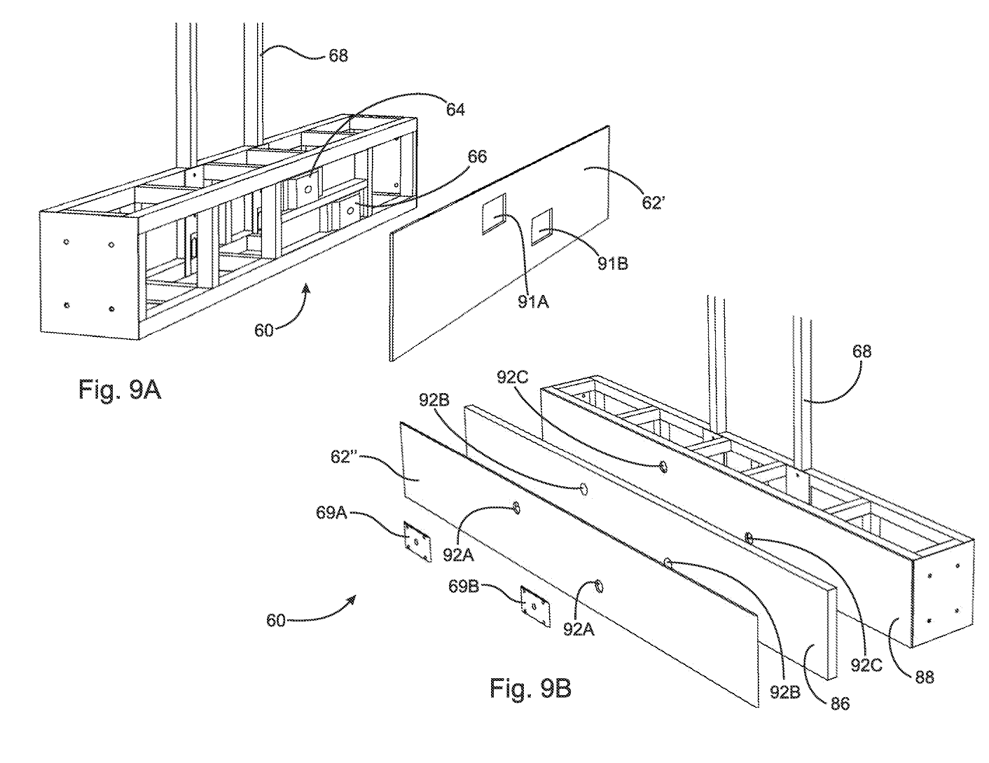

Further examples of side walls 62 are provided in FIGS. 9A and 9B, which illustrate assemblies for side walls 62′ and 62″. In FIG. 8A, assemblies 64 and 66 are first fully assembled, such as shown in FIG. 7A or 7B, and installed on framework 68. Then, front wall 62′, having openings 91A and 91B, is placed over the contact assemblies, with the openings shaped and sized to accommodate passage of at least a portion of the contact assemblies therethrough. Thus, the faceplates of the assemblies that protrude out from the openings would be able to flex in and out in order to accommodate the bumper of a go-kart and ensure proper electrical connection between go-kart contacts and the charging station contacts. In the embodiment of FIG. 9B, however, only faceplates 69, namely, faceplates 69A and 69B, are included to provide contacts for the charging station. The faceplates are securable to the wall by fasteners such as bolts, screws, pins, rivets, etc. In this embodiment, cushion layer 86 is provided behind the entirety of wall 62″, such that the entire wall can flex in and out in response to go-karts entering a pit lane. Since foam rubber and the like looses its compressibility over time and with repeated use, providing a larger cushion layer spreads the absorbed forces and enables the cushion to work properly for a longer period of time. Over time, however, layer 86 may become permanently compressed to some degree, and spacers, such as solid blocks or portions resembling resilient portions 70 in FIG. 7A could be provided between the wall and the faceplates in order to extend the faceplates out from wall 62″ and ensure that the faceplates continue to provide proper electrical connection between the go-kart and charging station contacts to complete the charging circuit. Backing plate 88 is provided to add support behind the cushion. An opening for connecting wiring to contact faceplates 69A and 69B is formed from holes 92A, 92B, and 92C in wall 62″, cushion 86, and backing plate 88, respectively.

It should thus be appreciated that the charging contacts for both the go-karts and the charging stations are positioned in vertically orientated surfaces, such that the contacts are located at in the outer lateral surface of the go-kart bumper and on a wall or wall portion of the pit area. Advantageously, this significantly shortens the path between each battery charger and the charging contacts, which greatly reduces the cost for installing high capacity electrical wiring. Furthermore, it prevents the need to build the pit area on a raised platform, or having to cut trenches in the cement or concrete below the pit area. Furthermore, contacts 110 and 112 might be included on both sides of bumper 102 of each kart 100, such that the kart can pull into the pit lanes in either direction and get charged.

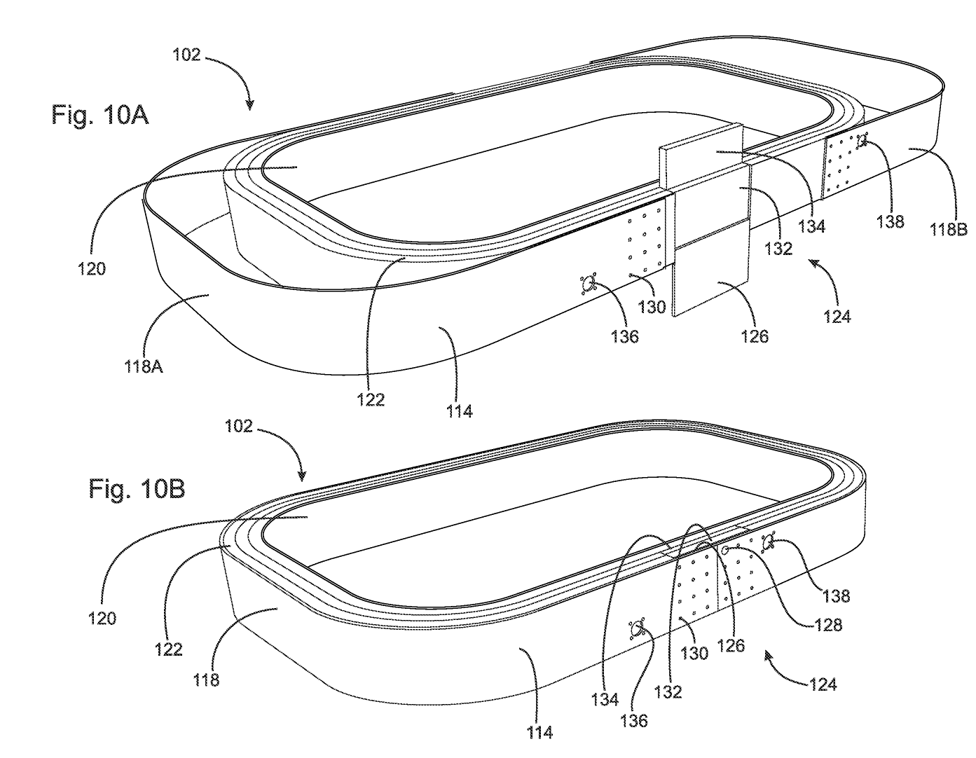

Bumper 102 of kart 100 is shown in more detail in FIGS. 10A and 10B. In this embodiment, bumper 102 comprises outer shell 118. Outer shell 118 may resemble, for example, shell 14 of bumpers 12 in that is a hard, semi-rigid layer, such as formed from hard plastic, for distributing loads throughout the bumper during a collision. Similar to backing 15, chassis ring 120 is provided to provide support for cushion layer 122, which is secured between the chassis ring and the outer shell. Cushion 122 is made, for example, from dense foam rubber in order to create sufficient thickness for absorbing, distributing, and dispersing the forces that result from collisions with bumper 102, such as described above with respect to cushions 16 for bumpers 12. In one embodiment, the chassis ring is made from aluminum or some other metal in order to provide substantially rigid support for the cushioning layer, although other materials could be used. As with bumpers 12, the cushion layer of bumper 102 may be formed from three layers of high density foam rubber secured together, such as with glue, epoxy, or other adhesives. Thus, by use of the cushioning layer, forces due to collisions are not transferred directly from bumper to the frame of the kart. Instead, the force is absorbed and distributed and transferred only though cushioning 112, which effectively dampens any impact before it is felt by the body of the go-karts, unlike prior art bumpers which are at least partially rigidly connected to their corresponding go-kart bodies/chassis.

In the embodiment of FIGS. 10A and 10B, outer shell 118 includes at least one joint 124 in order to form the bumper as a closed ring about the kart. In a preferred embodiment, there is a complementary joint on the opposite side of bumper 102 for splitting shell 118 into two substantially U-shaped pieces, namely, pieces 118A and 118B, for easier construction and maintenance. Joint 124 generally resembles joint 22 of bumpers 12 in that joint 124 also includes backing plate 126 which is securable to both portions of the outer shell via fasteners 128 through bores 130. Likewise, the fasteners may be screws, bolts, rivets, ratchet fasteners, or any other securing device known in the art. Cushion blocks 132 and/or 134 may be included with at least one of them having a reduced thickness in order to accommodate for the thickness of backing plate 126. Openings 136 and 138 are also included in lateral surface 114 of the outer shell of the bumper in order to accommodate passage therethrough of wiring in order to connect contacts 110 and 112 to the battery of the kart. Thus, contacts 110 and 112 would be secured over openings 136 and 138, such as via screws, bolts, or the like. Similar holes may need to be made in cushioning 122 and chassis ring 120 to enable the wiring to travel from the battery in the body of kart 100 to the contacts on the exterior of the bumper.

Prior art bumper karts could not be charged with wall mounted charging stations, because the bumpers of those karts were made of metal, and therefore conductive. In other words, placing charging contacts on the exterior sides of prior art bumpers would electrify the bumpers and frames of those prior art karts, which could cause damage to the karts and be extremely dangerous for drivers. As a result, prior art charging contacts are located underneath the karts, away from the conductive bumpers. This required corresponding electrical contacts in the floor or road surface of the pit lanes. As discussed above, in order to get the electrical wiring to the pit lane charging contacts, the pit lanes had to be built on an expensive raised platform, which is often impractical or impossible, particularly for indoor tracks. Alternatively, trenches had be dug underneath the track for laying the electrical wiring. Since the track must be paved for the karts to drive on, once the trenches are dug and electrical wiring is laid, the trenches and wiring would be at least partially contained in or covered by concrete or some other road material. As a result, the prior art pit lane charging contacts are expensive and difficult to install, and nearly impossible to perform maintenance on without tearing up the pit lanes and re-laying concrete or another road surface. Furthermore, less wiring is required for the current invention since it is a longer distance to travel under the track to underneath the middle of each pit lane than it is to travel from a position on a wall to another position on a wall. This is important because very thick cables are needed to handle the high currents necessary to charge the batteries of the kart batteries, which cables are extremely expensive. Furthermore, when located on the ground, the contacts must be constantly cleaned of dirt, grime, dust, and the like which accumulates on the contacts over time. Furthermore, it becomes a safety hazard if such contacts are used outdoors in the rain or are otherwise subjected to water. This is not such an issue if the contacts are located in side walls.

It should again be appreciated in general that other materials or dimensions could be used other than those shown and described herein. However, some guidelines have been provided for selection of dimensions and materials that have been found to work. For example, the dimensions and materials of the outer shell of the bumpers should be chosen such that the bumpers are not too stiff or too flexible. If too stiff, they would not compress, and therefore would result in sudden stops and perhaps even whiplash to the driver and vehicle. If too pliable, then the bumpers would not absorb or disperse the impact outwards away from the karts, for lessening the impact to the karts and driver. Again, the particular materials chosen should reflect the speeds and weights of the karts, age of the drivers, performance desired by the operator of the go-kart track, etc.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A bumper assembly comprising:
a backing, wherein said backing is substantially rigid;
an outer layer, wherein said outer layer semi-flexible, resilient, and non-conductive;
a cushion layer sandwiched between said backing and said outer layer, wherein said cushion layer is resiliently compressible.

2. The bumper assembly recited in claim 1, wherein said outer layer comprises hard plastic and said cushion layer comprises foam rubber.

3. The bumper assembly recited in claim 1, wherein said bumper assembly is installed as a substantially continuous ring about a go-kart.

4. The bumper assembly recited in claim 3, wherein said go-kart comprises a chassis, said chassis comprises said backing, wherein said outer layer comprises hard plastic, and wherein said cushion layer comprises foam rubber.

5. The bumper assembly recited in claim 4 wherein said outer layer comprises an outer lateral surface, and wherein at least one conductive contact is arranged on said outer lateral surface, and wherein said at least one conductive contact is electrically connected to a rechargeable battery of said go-kart.

6. The bumper assembly recited in claim 1, wherein said bumper assembly is arranged on a floor to define a track for vehicles, wherein said outer layer faces said track.

7. The bumper assembly recited in claim 6 further comprising a plurality of rods vertically extending from said floor at spaced intervals behind said backing for rigidly supporting said bumper assembly.

8. The bumper assembly recited in claim 7, wherein each of said rods includes a portion that extends down into said floor.

9. The bumper assembly recited in claim 8, wherein a brittleness of each of said rods enables said rods to shear or break between said backing and said floor if said rods experience a threshold force exerted by said backing

10. The bumper assembly recited in claim 7 further comprising a plurality of ties, wherein each of said ties corresponds with one of said rods, and each tie is operatively arranged for securing said outer layer, said cushion layer, and said backing to one of said rods.

11. The bumper assembly recited in claim 10, wherein said ties comprise plastic tie-wraps.

12. The bumper assembly recited in claim 7, wherein said backing comprises first and second backings, said cushion layer comprises first and second cushion layers, and said outer layer comprises first and second outer layers, wherein said first cushion layer is sandwiched between said first outer layer and said first backing for forming a first bumper portion and wherein said second cushion layer is sandwiched between said second outer layer and said second backing for forming a second bumper portion, and wherein said first and second bumper portions are arranged on oppositely disposed sides of said rods.

13. The bumper assembly recited in claim 12 further comprising a plurality of ties, wherein each of said ties corresponds to one of said rods, and wherein each of said ties is operatively arranged to secure both of said first and second bumper portions to common ones of said rods.

14. A system for electric vehicles comprising:
a track;
a pit area connected to said track and having at least one charging station, said charging station comprising:
a battery charger providing a voltage source;
at least one first contact electrically connected to said charging station, wherein said at least one first contact is arranged on a vertically oriented surface of said charging station; and,
an electric vehicle comprising:
a rechargeable battery;
a bumper having an outer lateral surface; and,
at least one second contact electrically connected to said rechargeable battery for completing a charging circuit between said battery charger and said battery when said second contact is engaged against and electrically connected to said first contact for recharging said battery.

15. The system of claim 14, wherein a cushion layer is provided behind said at least one first contact for enabling said at least one first contact to flex away from said bumper in case of interference between said at least one first contact and said at least one second contact for providing mating engagement of said first and second contacts against each other.

16. The system of claim 14, wherein said at least one first contact comprises two first contacts, said at least one second contact comprises two second contacts, and wherein a charging circuit for recharging said battery is completed only when each first contact is engaged against and conductively connected with respective ones of said second contacts.

17. A charging station comprising:
a battery charger providing a voltage source;
two conductive faceplates, wherein each conductive faceplate is electrically connected to said battery charger, wherein both of said conductive faceplates are arranged on a vertical surface.

18. The charging station recited in claim 17, wherein a cushion layer is provided behind said conductive faceplates for enabling said faceplates to move forward and back with respect to said vertical surface.
